(19) United States
(12) Patent Application Publication
(10) Pub. No.: US 2011/0307922 A1
(43) Pub. Date: Dec. 15, 2011

(54) MAKING AVAILABLE PREVIOUSLY BROADCAST PROGRAMMING

(75) Inventor: Alastair Stephenson, West Yorkshire (GB)

(73) Assignee: ELDON TECHNOLOGY LIMITED, Keighley (GB)

(21) Appl. No.: 13/145,980

(22) PCT Filed: Jan. 14, 2010
(86) PCT No.: PCT/EP10/50405

§ 371 Date: Sep. 1, 2011

(30) Foreign Application Priority Data
Jan. 23, 2009 (EP) 09151272.3

(51) Int. Cl. H04N 21/472

(52) U.S. Cl. 725/40

(57) ABSTRACT

An electronic program guide indicates the time of presentation and the channel or source of various programs. By use of a remote control device, a user is able to navigate the electronic program guide to highlight and then select a particular program which is being broadcast at the present time. The electronic program guide is displayed by a receiver which is networked with other receivers. The electronic program guide is also enabled to present details of various programs which were broadcast at a time earlier than the present time. Some of those earlier programs have been stored and that is also indicated. A user, by use of the remote control device can navigate backwards in time in the electronic program guide to an earlier stored program. This earlier program can then be highlighted and selected. It is then either downloaded to the user's receiver or streamed in real time to the user's receiver.

### CROSS-REFERENCE TO RELATED APPLICATIONS

This application is a U.S. National-Stage entry under 35 U.S.C. § 371 based on International Application No. PCT/EP2010/050405, filed Jan. 14, 2010, which was published under PCT Article 21(2) and which claims priority to European Application No. EP 09151272.3, filed Jan. 23, 2009.

### TECHNICAL FIELD

The present invention relates to a method and network for making available programming which was previously broadcast, and to an electronic program guide for enabling access to broadcast programming.

### BACKGROUND

Receiving devices for receiving broadcast audio/visual programming are frequently able to display an electronic program guide to enable the user to choose current or future programming either for presentation or to be recorded and stored. Such a receiving device may include a set top box with a hard disk for storage. The set top box may have prompt programs which invite the user to record an upcoming program, for example, because the same or similar program was previously recorded. However, users will still find that they have missed an earlier broadcast program which they wanted to view and which they have not arranged to record.

### BRIEF SUMMARY

The present invention seeks to provide a user with access to broadcast programming even though it was available in the past.

According to a first aspect of the present invention there is provided an electronic program guide for enabling access to broadcast programming, the electronic program guide presenting the time of presentation and the channel or source of various programs, and, upon selection by way of a user interface of a particular program at the present time at which the program is being broadcast, causing the particular selected program to be accessed and presented, wherein the electronic program guide is also enabled to present details of various programs which were broadcast at a time earlier than the present time, at least some of which have been stored, and wherein, upon selection by way of a user interface of an earlier, stored program, the electronic program guide causes the selected earlier stored program to be accessed and presented.

Currently, the electronic program guide is either compiled or finalised at the set top box utilising information from the content provider and/or head-end. The programming information which is available in an electronic program guide is current or in the future. Details of earlier broadcast programs, which are no longer available, are removed from the electronic program guide.

The present invention proposes that earlier available programs should be recorded or otherwise stored and their availability then made evident to a user by being presented in the electronic program guide. Thus, the electronic program guide would look much the same as those currently available except that the user would be able to scroll backwards through content in the past. Where the earlier content had been stored, it would then be accessible by way of the electronic program guide in the usual manner.

Preferably, the electronic program guide is arranged to be displayed on a screen associated with a local receiver of broadcast programming.

In known manner, a user is enabled to highlight a program for presentation. If the highlighted program is then selected, it is caused to be displayed either in conjunction with the electronic program guide or in its place.

In one embodiment, the local receiver of broadcast programming comprises a receiving device having means arranged to receive and present broadcast programming, processing means arranged to present the electronic program guide, at least one user interface, and means for storing one or more programs. In a particularly common implementation, the receiver may comprise a TV receiver with a screen, a set top box arranged to receive the programming and coupled to the TV receiver, and a user interface in the form of a remote control.

The present invention also extends to a method of making available programming which was previously broadcast, the method comprising:

identifying earlier programs, which have already been broadcast, and which have been stored by at least one receiving device party to a network,

causing details of the identified earlier stored programs to be incorporated into electronic program guides of receiving devices party to the network such that the earlier stored programs are available for presentation, and

in response to the selection, by way of a user interface of one receiving device of the network, of an earlier, stored program, causing that selected earlier stored program to be accessed for presentation by said one receiving device.

It will be appreciated that when there are many users, one or more of them may have occasion to record a program of interest to other users. With the invention it is proposed that these already recorded programs be made available to other users. It is thus proposed that the receiving devices of a number of users should be networked. The fact that these programs have been recorded and, thus, are available is signalled by the provision of an electronic program guide at each networked receiving device which indicates the availability of programming which was broadcast earlier than the present time.

In one embodiment, the method further comprises causing the selected, earlier, stored program to be downloaded to said one receiving device for local storage and subsequent presentation.

Thus, having identified the availability of an earlier program of interest, a user can arrange for it to be downloaded to his local receiving device. For example, it may be recorded to the disk of the user's set top box. The user may then access the program, as he would any other recorded programming, at his convenience and present the program for listening or viewing.

Additionally and/or alternatively, the method may comprise enabling streaming delivery of the selected, earlier, stored program to said one receiving device for contemporaneous presentation by said one receiving device.

In this case, once the program has been located, it is simply streamed for contemporaneous viewing to the user who has asked for it by way of the electronic program guide.

Preferably, the method further comprises forming at a server of the network a list of earlier stored programs, and causing the formed list to be incorporated into the electronic program guides to be presented by each receiving device of the network.

When a user wishes to access a stored program, it is highlighted and selected by use of the electronic program guide. The server then couples the user's receiving device to the receiving device where the required program is stored.

In an embodiment, the server of the network is caused to periodically interrogate the receiving devices of the network to identify which earlier programs have been stored and then to update the formed list. Preferably, it is a server which identifies the available stored content and provides individual receiving devices with the necessary information to enable the electronic program guide presented by those receiving devices to reveal the existence of content from the past.

If required, individual servers could be networked in their turn to increase the coverage of the network. This increases the chance that any particular user of the network will be able to access required content that has been recorded.

The content which is accessed and stored by receiving devices of the network may be content which should only be made available to subscribers. For example, the content may be individual programs available on a pay-per-view basis or may be a channel available only by subscription such that no programs broadcast should be freely available. It is proposed that control of the content should be by the one or more servers provided in the network.

In an embodiment, the method further comprises enabling the server to obtain details of subscription terms and conditions appertaining to each receiving device, and enabling the server to make a selected, stored, program available to said one receiving device only where the subscription terms appertaining to said one receiving device allow such availability.

The present invention also extends to a network for making available programming which was previously broadcast, the network comprising:

a plurality of receiving devices coupled to form a network,

each receiving device having means arranged to receive and present broadcast programming, processor means arranged to present an electronic program guide to identify the time of presentation and the channel or source of various programs, at least one user interface, and means for storing one or more programs received by said receiving and presenting means, and

at least one server coupled to the network such that it is arranged to communicate with a plurality of the receiving devices in the network,

the server being arranged to identify earlier programs, which have already been broadcast, and which have also been stored by at least one receiving device of the network, and to cause details of the identified earlier stored programs to be incorporated into the electronic program guides of the receiving devices.

Preferably, the receiving devices coupled by the network communicate with the server, and with each other, using internet protocol (IP).

By use of the network, users are able to access earlier programs which have been recorded or otherwise stored by other receiving devices of the network.

Preferably, the receiving device seeking the earlier stored program is put in contact with the receiving device on which the content is stored by way of the server. Thus, although the two receiving devices can be in peer-to-peer connection, neither needs to know the address of the other.

Preferably, the server is coupled to a broadcast provider and is enabled to receive subscription terms and conditions appertaining to each receiving device.

Whilst it is helpful if users are able to access content they have missed, it is important that such controls as the content owners have placed on the programs are respected. By providing the server with subscription terms and conditions the server can be arranged to ensure that only content which a user has paid for, or which is freely available, is shared over the network.

According to a further aspect of the present invention there is provided a receiver of broadcast programming comprising means arranged to receive and present broadcast programming, processor means arranged to present an electronic program guide to identify the time of presentation and the channel or source of various programs, at least one user interface, and means for storing one or more programs received by said receiving and presenting means, wherein the receiver is arranged to communicate with a network and to receive information about earlier programs which have been stored by the network, and wherein the processor means is arranged to present an electronic program guide incorporating details of various programs which were broadcast at a time earlier than the present time and to identify any such earlier programs that had been stored by the network and are available.

A receiver of the invention is enabled to provide and to present an electronic program guide of the invention enabling the user to scroll backwards through earlier content, and to identify and access earlier programs that have been stored by the network.

In an embodiment, the receiver is arranged to communicate to the network details of broadcast programs stored by said storing means.

Each receiver is arranged to give details of any broadcast programs it has stored to the server of the network. This enables the server to develop a list of earlier programs which have been stored for provision to all of the receivers and for presentation in the electronic program guides.

It will be appreciated that it will generally be impractical to make content available which has been stored for a substantial period of time. In practice the earlier stored content might be that available during the preceding 24 hours.

In an embodiment, the receiver is arranged upon request to make stored programs available to other receiving devices of the network, the processor means being arranged to reencrypt any stored programs which were decrypted on receipt before making the programs available.

As earlier explained, where content is not free to air, the controls and terms imposed by the content providers have to be respected. Thus, if a receiver, which is entitled to receive content from a subscription channel, for example, receives and records a program it will decrypt the content and store it in decrypted form. It is therefore important to ensure that that receiving device reencrypts the content before making it available to another receiver on the network.

The present invention also extends to a server for a network of receiving devices for broadcast programming, the server being arranged to be in communication with each receiving device in the network, the server being arranged to receive information from the receiving devices identifying any earlier broadcast programs that had been received and stored, the server being arranged to list the earlier stored programs available, and to communicate the list to the receiving devices such that each receiving device is enabled to present an electronic program guide not only identifying present and future programs for selection, but earlier, stored programs.

The server may be in communication with other servers whereby the size of the network is increased.

Software can be provided at the server to enable the necessary communications of the network to take place and to control the gathering of information from individual receivers and to facilitate the provision of electronic program guides with the backwards capability at each receiver.

### BRIEF DESCRIPTION OF THE DRAWINGS

Preferred embodiments of the present invention will hereinafter be described, by way of example, with reference to the accompanying drawings in which:

FIG. 1 shows schematically the provision of programming by way of a set top box to a display on a television set,

FIG. 2 shows an example of an electronic program guide of the invention as presented on the display of a television set, and

FIG. 3 illustrates a network of receiving devices of the present invention.

### DETAILED DESCRIPTION

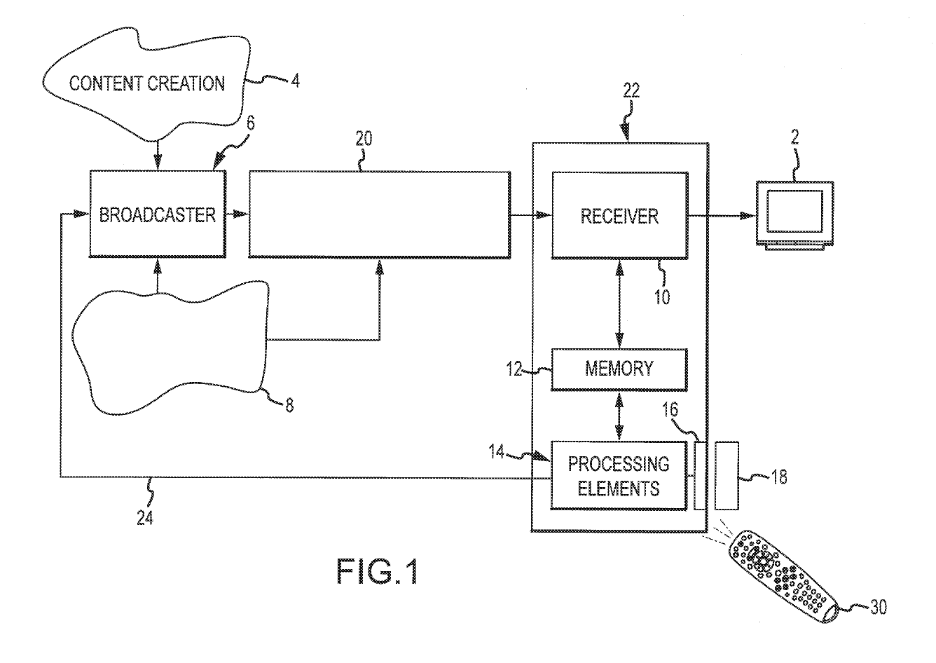

In this specification we refer to a receiver for broadcast programming. This is shown in FIG. 1, for example, as a set top box 22 in conjunction with a television receiver 2 having a display. However, it will be understood that the set top box comprehends any digital device able to impart functionality to a television receiver whether provided in a stand-alone box, incorporated in a stand-alone box along with other devices, or integrated within the television receiver. In addition, the receiver will have presentation means, usually comprising speakers and a display screen. The presentation means will be incorporated within the receiver or provided separately. Similar functionality may also be obtained by use of a computer with a monitor and speakers. All such arrangements, and any other hardware, be they distributed or packaged within a stand-alone box are within the scope of this application.

FIG. 1 shows schematically the provision of programming by way of a set top box 22 to a television receiver 2. Programming content, that is video and audio data, is created as indicated at 4 and is provided to a network provider or broadcaster 6 for transmission. The video and audio content 4 is combined for transmission with information and control data 8. This information and control data 8 may include teletext information, and other material, including data, such as graphics, for display. The information and control data 8 also incorporates data to command and control operation of the set top box 22 and the TV receiver 2. For example, the control data 8 may require the set top box to interrogate a viewing card to check authorisations.

The information and control data may be supplied to the broadcaster 6 for combination with the programming content 4 or it may be fed separately to a multiplexer 20 which is arranged to packetise and multiplex the programming content and the information and control data into a transport stream in accordance with the appropriate standards. It is this material which is then transmitted by any appropriate means to a set top box 22. As is well known, the set top box includes a receiver 10 for receiving the transmitted programming, a memory 12 and a processing unit 14. The processing unit has a card reader 16 in which a viewing card 18 can be inserted. Operation of the set top box 22 is controlled by a remote control device 30 which is in communication with the processing unit 14 of the set top box 22 by way, for example, of infrared communication.

The set top box 22 may also be arranged to communicate with the broadcaster 6. For example, and as illustrated, there may be a telephonic connection 24 between the processing unit 14 and the broadcaster 6. This communication between the set top box 22 and the broadcaster 6 can be two-way to enable, for example, the set top box to obtain from the broadcaster information and control data 8 indicating whether or not the subscriber's account identified on the viewing card 18 is up to date.

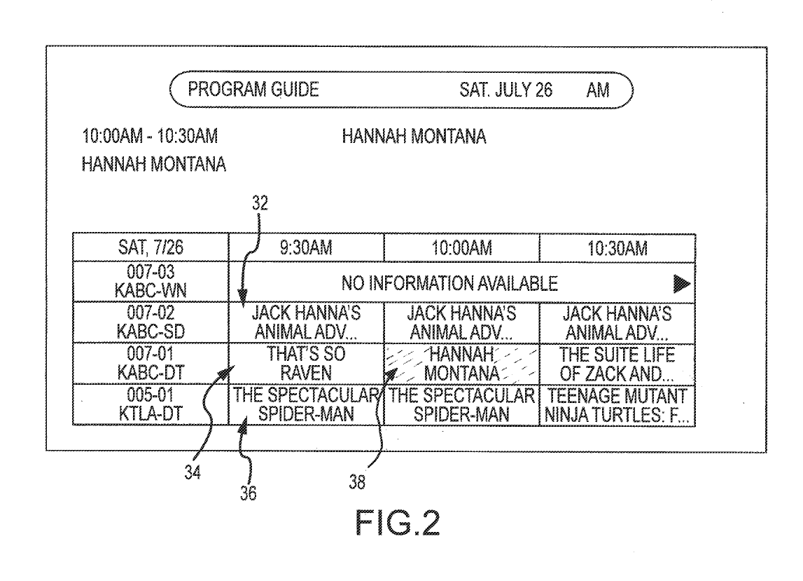

In order to access programming it is usual to display an electronic program guide on the screen of the receiver 2. Thus, a user would, by way of the remote control device 30, request of the set top box 22 details of programs available. The processor 14 either receives an electronic program guide from the broadcaster 6 or, more usually, receives the necessary information, creates the electronic program guide, and causes it to be displayed on the screen of the receiver 2. The electronic program guide identifies the channels available and current and future programs, as indicated in FIG. 2. By use of the remote control device 30 the user is able to scroll between channels and programs. If the user highlights a currently available program, such as the program “Hannah Montana” 38 shown in FIG. 2, and then selects that program using the remote control 30, the program will be tuned to by the receiver 10 of the set top box 22 and displayed on the screen of the receiver 2.

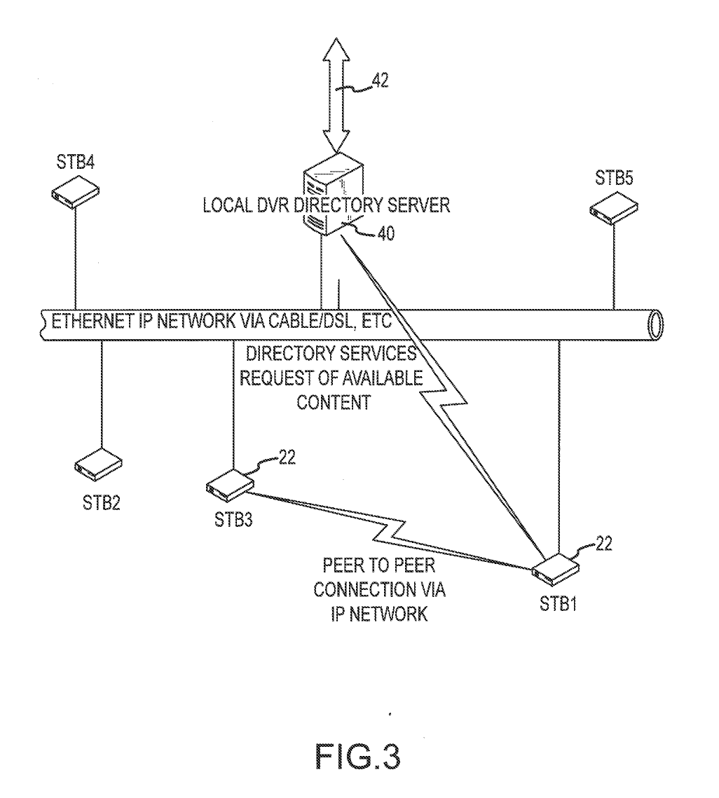

It frequently happens that a user misses a program they wanted to view. For example, the user may have forgotten to record a favourite program, or switches on the receiver during the course of the program or after it has finished. FIG. 3 shows an example of a network which can enable a user to have access to broadcast programs which occurred in the past, usually in the recent past, say within the last 24 hours.

As is shown in FIG. 3, a number of set top boxes 22 of different receivers are networked to each other and to a server 40. It will be seen that the set top boxes 22 in different locations are identified as STB1, STB2 . . . . The network can be configured in any appropriate manner but it is preferred that communication between the set top boxes 22 and to the server 40 is by way of internet protocol (IP). Each set top box 22 is arranged to communicate with the server 40. At specified time periods each set top box 22 is arranged to provide to the server a list of the content that it has recorded locally in its memory or hard disk 12. This communication of content to the server 40 can be initiated by the set top boxes 22 at different times or can be in response to interrogations from the server 40. The server 40 will compile a list of the stored content and also stores information as to where that content is stored. The list of available stored content will cover all content stored in the last 24 hours.

FIG. 2 shows an electronic program guide of the invention at 10 a.m. and indicates in a first column programs available at 10 a.m., and in a second column later programs at 10.30a.m. In this sense the electronic program guide will be as usual and as expected. However, there is a further column to the left of 10 a.m. which shows programs that have finished but which may be still available. Thus, the further column to the left is indicating programs in the past. In addition, the individual programs in the past may be colour coded to indicate availability. The first item in the further column, item 32, is in red to indicate that it has not been recorded and hence is not available. List item 34 is in dark green to show that the content is available for download or for real time buffering via a peer-to-peer connection. The third item 36 is coloured light green to show that this content has been downloaded to the local hard drive 12 and is available for viewing now. Other content which has been recorded locally might be shown in light green to indicate availability.

The content which is currently highlighted for selection is item 38 “Hannah Montana”. The other items in the 10 a.m. and 10.30 a.m. columns have a white background, to indicate that they are events which are either available presently or will be available in the usual way in the future.

An electronic program guide is usually navigated by the use of cursors on the remote control unit 30, and the guide shown in FIG. 2 can be similarly navigated. However, and as will be appreciated, the electronic program guide of FIG. 2 can be navigated backwardly in time.

We have seen that the server 40 compiles a list of content which was broadcast earlier and which is available because it has been recorded on one or more set top boxes. The server 40 makes this list available to each set top box 22 and enables each set top box to generate and display an electronic program guide, as shown in FIG. 2, which additionally includes earlier programs together with an indication as to whether any particular past program has been stored on the network. The user uses the remote control device 30 to navigate the electronic program guide of FIG. 2 backwardly in time and to identify a program which has been recorded and is available. For example, the user might identify the program “That's So Raven” at 34. As far as the user is concerned, this content is accessed by selecting it in the normal way. The user is then given the option to download the content or to stream it in real time. Having chosen the form of receipt, the set top box of the user, for example STB1 of FIG. 3 is put into peer-to-peer connection via an IP network with STB3 which has the content stored. As the connection is established by the server 40 neither of the set top boxes needs to know the address of the other.

If the user has chosen that the content be downloaded, this will then occur and the program will appear shortly thereafter in the user's electronic program guide as an item as 36 indicating that it is locally stored. The program can then be accessed in the usual way. If the user has chosen to watch it in real time, the stored content on set top box STB3 is streamed to the user's set top box STB1 and is buffered and presented in the usual manner.

It will be seen in FIG. 3 that the server 40 is provided with a connection 42. This connection will be to the broadcaster 6 or to a holder of subscription information. The server 40 will not put two set top boxes in communication, for example, if the content to be downloaded or streamed is not available to the user requesting it. This may occur, for example, if the content was on a subscription channel to which the requesting user is not subscribed, or if the content was pay per view and has not been paid for.

It will be appreciated that the invention provides users with access to stored programs without it being necessary to establish a central database of programs. The functionality for obtaining the programs is substantially the same as the familiar electronic program guide so that it is very easy for a user to access programs.

Network DVR has been proposed but in such arrangements a large number of hard disks are required for storage. In this case, use is made of the storage capacities of the networked set top boxes, each of which already has a hard disk which may not be fully utilised.

An advantage of the invention is that the user of a set top box is enabled to read backwards through the electronic program guide and to access events that they have missed or that they forgotten to record.

It may be that the program which has been stored on a set top box has been decrypted for receipt and storage by the set top box, for example, because it was available from a subscription channel. The processor 14 of that set top box will be arranged to reencrypt the content before providing it to a requesting set top box. If the requesting set top box is subscribed to the same channel, for example, it will be able to use its own key to gain access to the encrypted material.

It will be appreciated that modifications and amendments may be made to the embodiments as described and illustrated within the scope of the accompanying claims.

1. An electronic program guide for enabling access to broadcast programming, the electronic program guide presenting the time of presentation and the channel or source of various programs, and, upon selection by way of a user interface of a particular program at the present time at which the program is being broadcast, causing the particular selected program to be accessed and presented, wherein the electronic program guide is also enabled to present details of various programs which were broadcast at a time earlier than the present time, at least some of which have been stored, and wherein, upon selection by way of a user interface of an earlier, stored program, the electronic program guide causes the selected earlier stored program to be accessed and presented.

2. An electronic program guide as claimed in claim 1, arranged to be displayed on a screen associated with a local receiver of broadcast programming.

3. A method of making available programming which was previously broadcast, the method comprising:
identifying earlier programs, which have already been broadcast, and which have been stored by at least one receiving device party to a network,
causing details of the identified earlier stored programs to be incorporated into electronic program guides of receiving devices party to the network such that the earlier stored programs are available for presentation, and
in response to the selection, by way of a user interface of one receiving device of the network, of an earlier, stored program, causing that selected earlier stored program to be accessed for presentation by said one receiving device.

4. A method of making available programming which was previously broadcast, as claimed in claim 3, further comprising causing the selected, earlier, stored program to be downloaded to said one receiving device for local storage and subsequent presentation.

5. A method of making available programming which was previously broadcast as claimed in claim 3, further comprising enabling streaming delivery of the selected, earlier, stored program to said one receiving device for contemporaneous presentation by said one receiving device.

6. A method of making available programming which was previously broadcast as claimed in any of claims 3, the method further comprising forming at a server of the network a list of earlier stored programs, and causing the formed list to be incorporated into the electronic program guides to be presented by each receiving device of the network.

7. A method of making available programming which was previously broadcast as claimed in claim 6, further comprising causing the server of the network to periodically interrogate the receiving devices of the network to identify which earlier programs have been stored in preparation for the formation of the list.

8. A method of making available programming which was previously broadcast as claimed in claim 6, further comprising enabling the server to obtain details of subscription terms and conditions appertaining to each receiving device, and enabling the server to make a selected, stored, program available to said one receiving device only where the subscription terms appertaining to said one receiving device allow such availability.

9. A system for making available programming which was previously broadcast, the system comprising:
a plurality of receiving devices coupled to form a network,
each receiving device being arranged to receive and present broadcast programming, and each comprising a processor configured to present an electronic program guide to identify the time of presentation and the channel or source of various programs, at least one user interface, and storage configured to store one or more programs received by said receiving device, and
at least one server coupled to the network such that it is arranged to communicate with the plurality of the receiving devices in the network,
the server being configured to identify earlier programs, which have already been broadcast, and which have also been stored by at least one receiving device of the network, and to cause details of the identified earlier stored programs to be incorporated into the electronic program guides of the receiving devices.

10. A system for making available programming which was previously broadcast as claimed in claim 9, wherein the receiving devices coupled by the network communicate with the server using internet protocol (IP).

11. A system for making available programming which was previously broadcast as claimed in claim 9 wherein the server is coupled to a broadcast provider and is enabled to receive subscription terms and conditions appertaining to each receiving device.

12. A receiver of broadcast programming comprising means arranged to receive and present broadcast programming, processor means arranged to present an electronic program guide to identify the time of presentation and the channel or source of various programs, at least one user interface, and means for storing one or more programs received by said receiving and presenting means, wherein the receiver is arranged to communicate with a network and to receive information about earlier programs which have been stored by the network, and wherein the processor means is arranged to present an electronic program guide incorporating details of various programs which were broadcast at a time earlier than the present time and to identify any such earlier programs that had been stored by the network and are available.

13. A receiver of broadcast programming as claimed in claim 12, arranged to communicate to the network details of broadcast programs stored by said storing means.

14. A receiver of broadcast programming as claimed in claim 12, arranged upon request to make stored programs available to other receiving devices of the network, the processor means being arranged to reencrypt any stored programs which were decrypted on receipt before making the programs available.

15. A server for a network of receiving devices for broadcast programming, the server being arranged to be in communication with each receiving device in the network, the server being arranged to receive information from the receiving devices identifying any earlier broadcast programs that had been received and stored, the server being arranged to list the earlier stored programs available, and to communicate the list to the receiving devices such that each receiving device is enabled to present an electronic program guide not only identifying present and future programs for selection, but earlier, stored programs.
